(19) United States
(12) Patent Application Publication
(10) Pub. No.: US 2026/0129576 A1
(43) Pub. Date: May 7, 2026

(54) SCHEDULING OF SLEEP AND AWAKE MODES IN WIRELESS COMMUNICATION

(71) Applicant: Nokia Technologies Oy, Espoo (FI)

(72) Inventors: Behnam DEZFOULI, Sunnyvale, CA (US); Klaus Franz DOPPLER, Sunnyvale, CA (US)

(21) Appl. No.: 18/936,621

(22) Filed: Nov. 4, 2024

(51) Int. Cl. H04W 52/02

(52) U.S. Cl. CPC H04W 52/0225

(57) ABSTRACT

The present subject matter relates to a method comprising operating during a time window, according to one or more schedules, the schedule defining a sleep mode and an awake mode of an apparatus, referred to as first apparatus, within the time window, to enable a communication by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

### TECHNICAL FIELD

Various example embodiments relate to telecommunication systems, and more particularly to apparatuses, methods and computer readable media for wireless communication.

### BACKGROUND

In wireless communication systems, the efficient coordination of devices on shared communication channels may be used for maintaining data integrity and performance, especially when employing mechanisms like enhanced distributed channel access (EDCA). EDCA allows a station such as an access point (AP) to reserve a transmission opportunity (TXOP) and communicate with one or more apparatuses using the same communication channel, preventing collisions and ensuring smooth data transmission. During a reserved TXOP, virtual carrier sensing may be used to signal devices on the communication channel to refrain from transmitting, allowing the apparatus that has reserved the TXOP to communicate with one or more other apparatuses without interference. To enhance energy efficiency, energy-saving protocols like VHT TXOP Power Save may allow devices not involved in a current TXOP to enter sleep mode. However, there is a growing need to improve these mechanisms.

### SUMMARY

Example embodiments provide an apparatus, referred to as first apparatus, for a wireless communication system, the apparatus comprising at least one processor; and at least one memory storing instructions that, when executed by the at least one processor, cause the first apparatus at least to: operate during a time window, according to one or more schedules, each schedule of the one or more schedules defining a sleep mode and an awake mode of the first apparatus within the time window, to enable a communication, referred to as first communication, by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

Example embodiments provide a method comprising: operating during a time window, according to one or more schedules, each schedule of the one or more schedules defining a sleep mode and an awake mode of an apparatus, referred to as first apparatus, within the time window, to enable a communication, referred to as first communication, by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

Example embodiments provide a non-transitory computer readable medium comprising program instructions that, when executed by an apparatus, cause the apparatus to perform at least the method.

Example embodiments provide an apparatus, referred to as third apparatus, for a wireless communication system, the third apparatus comprising at least one processor; and at least one memory storing instructions that, when executed by the at least one processor, cause the third apparatus at least to: receive from an apparatus referred to as first apparatus, one or more schedules, each schedule of the one or more schedules defining sleep and awake modes of the first apparatus within a time window to enable a communication, referred to as first communication, by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

Example embodiments provide a method comprising: receiving from an apparatus referred to as first apparatus, one or more schedules, each schedule of the one or more schedules defining sleep and awake modes of the first apparatus within a time window to enable a communication, referred to as first communication, by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

Example embodiments provide a non-transitory computer readable medium comprising program instructions that, when executed by an apparatus, cause the apparatus to perform at least the method.

“First,” “Second,” “Third,” etc. as used herein, these terms are used as labels for nouns that they precede, and do not necessarily imply any type of ordering (e.g., spatial, temporal, logical) unless explicitly defined as such.

### BRIEF DESCRIPTION OF THE DRAWINGS

The accompanying figures are included to provide a further understanding of examples, and are incorporated in and constitute part of this specification. In the figures:

FIG. 1 illustrates an example wireless communication system in which the present subject matter may be implemented in accordance with an example;

FIG. 2 is a flowchart of a method for communication on a communication channel of a wireless communication system in accordance with an example of the present subject matter;

FIG. 3 is a flowchart of a method for communication on a communication channel of a wireless communication system in accordance with an example of the present subject matter;

FIG. 4 is a flowchart of a coordination method for determining a schedule in accordance with an example of the present subject matter;

FIG. 5 is a flowchart of a coordination method for determining a schedule in accordance with an example of the present subject matter;

FIG. 6 is a diagram illustrating the status of the access to the communication channel by a set of stations in accordance with an example of the present subject matter;

FIG. 7 is a diagram illustrating the status of the access to the communication channel by a set of stations in accordance with an example of the present subject matter;

FIG. 8 is a diagram illustrating a method for determining a duty-cycling pattern in accordance with an example of the present subject matter;

FIG. 9 is a diagram illustrating two duty-cycling patterns with synchronized awake times of STAs in accordance with an example of the present subject matter;

FIG. 10 is a diagram illustrating two scenarios involving extendable and non-extendable awake durations for a STA within a TXOP interval in accordance with an example of the present subject matter; and

FIG. 11 is a block diagram showing an example of an apparatus according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

The present subject matter may aim to ensure reliable and efficient communication in dynamic and evolving wireless environments, promoting a more effective balance between energy conservation and low-latency communication within a wireless system. For example, it may address challenges in wireless communication systems, such as Wi-Fi, by enabling mechanisms that facilitate urgent data delivery to stations in sleep mode and improving coordination among multiple stations sharing a TXOP.

A first apparatus may be provided. The first apparatus may be configured to operate during a time window according to one or more schedules. In one example, the first apparatus may be configured to operate during the time window according to multiple schedules. Alternatively, the first apparatus may be configured to operate during the time window according to one schedule.

Each schedule of the one or more schedules may define a sleep mode and an awake mode of the first apparatus within the time window. The schedule may be indicative of when the first apparatus should enter the awake mode, such as to perform communication, and when it should switch to sleep mode, such as to conserve energy. For example, the schedule may specify at least one of: the duration of the awake mode and the sleep mode, the frequency of the awake mode and the sleep mode, the timing of the awake mode and sleep mode, the proportion of the time window allocated to each mode of the awake and sleep modes, the placement of each mode of the awake and sleep modes within the time window, wherein the placement may be either relative to the time window or as fixed points in time or the triggers for transitioning between awake and sleep modes based on specific events or conditions. These listed specifications may be referred to as schedule parameters. The schedule may also be referred to as operational mode.

Defining one or more schedules may allow the first apparatus to optimize its activity, reducing energy consumption and enhancing battery life without compromising on critical functions.

The first apparatus, when operating in sleep mode, may deactivate one or more components of the first apparatus. The deactivation may, for example, prevent the first apparatus from transmitting and/or receiving data. The one or more components may be configured for transmission, reception, and processing of data. For example, the one or more components may include at least one of: the transmitter, receiver, or processor. Conversely, the first apparatus, when operating in awake mode, may be configured to perform tasks such as transmitting, receiving, and processing data. Upon transitioning from sleep mode to awake mode, the first apparatus may reactivate the previously deactivated one or more components in the sleep mode.

The schedule may enable a communication, referred to as first communication, by the first apparatus during a time the first apparatus is in the awake mode. The first communication by the first apparatus may refer to the transmission and/or reception of data by the first apparatus on the communication channel. This may refer to the capability of the first apparatus to transmit or receive data over the communication channel while the first apparatus is in the awake mode.

The communication channel may refer to a specific frequency range, and transmitting data through this communication channel may involve encoding the data into signals that correspond to the frequency within that range. The communication channel may be used by the first apparatus and other apparatuses which may compete for access to the communication channel. Consequently, these apparatuses, including the first apparatus, may form a set of contending apparatuses. This contention can lead to interference, as all members of the set may be trying access to the same communication channel.

Each apparatus of the set of contending apparatuses may be any device capable of connecting to and communicating within the wireless communication system. The apparatus may include a client device, such as smartphone, laptop, and Internet of Things (IoT) device, or an access point. In one example, each apparatus of the set of contending apparatuses may comprise a station (STA), and thus may be referred to as station. The apparatus which is not an access point may comprise a station and may thus be referred to as non-AP station. Hence, the station may refer to an access point or a non-AP station. The apparatus may, for example, be configured to operate in accordance with EDCA mechanism and integrating the present subject matter for operating in accordance with the schedule during the time window.

The time window may be set or defined or obtained by at least a second apparatus. The at least second apparatus may be part of the set contending apparatuses for the communication channel. The time window may comprise one or more intervals which are set by the at least second apparatus respectively. In one example, the time window may be set by a second apparatus. Alternatively, the time window may be set by multiple second apparatuses. This may indicate that the time window for the first apparatus is set by another one or more second apparatuses which are contending on the communication channel. Using the time window which is set by another apparatus may enable coordination and concurrent access to the communication channel.

The time window is set by the at least second apparatus for performing communication, referred to as second communication, during (or within) the time window by the at least second apparatus on the communication channel. The at least second apparatus may be configured to use at least part of the time window to perform the second communication.

The terms ‘first’ and ‘second’ are used for labeling purposes. For example, the term ‘first apparatus’ may denote an apparatus capable of performing a ‘first communication’. When multiple such apparatuses are present, they are collectively referred to as ‘first apparatuses,’ with each individual apparatus being capable of performing the first type of communication involving its own data. The term ‘second apparatus’ may denote an apparatus capable of performing a ‘second communication’ which may be of a type different from a type of the first communication. When multiple such apparatuses are present, they are collectively referred to as ‘second apparatuses,’ with each individual apparatus being capable of performing the second type of communication involving its own data.

The first communication may, for example, have a higher priority than the second communication during a part of the time window. The first communication may thus be referred to as priority communication and the second communication may be referred to as regular communication.

Each apparatus in the set of contending apparatuses may be configured to announce a time during which it may have access to the communication channel. This announcement may be transmitted in a dedicated frame specifically designed for this purpose, or it could be included as a field within an existing frame, such as a control, data or management frame. This announcement may enable to coordinate channel access among the apparatuses.

Hence, the first apparatus may be configured to operate in accordance with the one or more schedules during the time window. If the one or more schedules is a single schedule, the first apparatus may operate in accordance with the schedule during the time window. If the one or more schedules are two or more schedules, the first apparatus may be configured to operate in accordance with the two or more schedules during the time window. In this case, the two or more schedules may be defined to work together in a complementary manner without conflict e.g., such that the transitions and overlaps between modes in each schedule do not interfere with one another. Alternatively, the first apparatus may be configured to operate in accordance with the two or more schedules by selecting one schedule from the two or more schedules and operating in accordance with the selected schedule during the time window. The selection may, for example, be performed based on specific conditions, priorities, communication needs of the first apparatus or instructions received from another apparatus.

The following description refers to the first apparatus operating under a single schedule. However, examples provided for a single schedule can, where applicable, be applied individually to each schedule in cases involving multiple schedules.

The wireless communication system according to the present subject matter may be a Wi-Fi system, but the disclosure is not limited to Wi-Fi alone. The wireless communication system may also be adapted for use in other wireless communication systems, such as cellular networks, and any other wireless protocols that involve managing access to a shared communication channel. The Wi-Fi system may, for example, operate in accordance with an IEEE 802.11 standard such as 802.11n, 802.11ac, 802.11ax, 802.11be, or 802.11bn.

According to one example, each apparatus of the first and second apparatuses comprises a station, wherein the schedule is a duty-cycling pattern, and the time window comprises a TXOP interval. The at least second apparatus may be one second apparatus. In this case, operating according to the schedule comprises performing a power duty cycling during the TXOP interval. The duty-cycling pattern may be an example implementation of the schedule. The duty-cycling pattern may, for example, be established by assigning specific values to respective schedule parameters of the schedule parameters. The duty-cycling pattern may be a predefined sequence of alternating sleep and awake time intervals. The duty-cycling pattern may indicate a systematic approach for scheduling when the first apparatus should be awake or asleep. The time window in this example includes the TXOP interval, which is a specific duration during which the second apparatus may have the exclusive right to transmit and receive data frames without contention. Power duty cycling may mean alternating by the first apparatus between awake mode and sleep mode within the TXOP interval in accordance with the duty-cycling pattern, where the term ‘power’ may emphasize the management of energy consumption by selectively activating and deactivating components, and ‘duty’ may refer to the proportion of time spent in the awake or sleep mode within a given interval.

According to one example, the first apparatus may be configured to coordinate the schedule with an apparatus, referred to as third apparatus. This example may be referred to as coordination example. The coordination may refer to a negotiation process between the first apparatus and the third apparatus to establish or agree upon the schedule. This may involve communicating and adjusting parameters to define a mutually compatible schedule. This coordination may ensure that the first apparatus operates efficiently within the agreed-upon schedule.

The first, second and third apparatuses may be part of the set of contending apparatuses.

According to one example, the first apparatus may be a station, and the third apparatus may be a station, with the schedule being the duty-cycling pattern. This example may serve as an implementation of the coordination example. This may mean that the first apparatus may be configured to coordinate the duty-cycling pattern with the third apparatus.

According to one example, the first apparatus may be configured to: receive from the third apparatus one or more candidate schedules for sleep and awake modes, select a candidate schedule of the one or more candidate schedules, wherein the schedule according to which the first apparatus operates is the selected candidate schedule. The one or more candidate schedules may consist of a single candidate schedule, in which case the selection involves directly choosing that candidate schedule. Alternatively, the one or more candidate schedules may include multiple candidate schedules, in which case the selection may involve evaluating and choosing one from the multiple candidate schedules. This example may serve as an implementation of the coordination example.

With this example the third apparatus may propose one or more candidate schedules, giving the first apparatus flexibility in selecting the most suitable option e.g., based on its preferences or requirements. This approach may be advantageous for scenarios where the first apparatus may need autonomy in making the final choice.

According to one example, the coordination of the duty-cycling pattern between the first apparatus and the third apparatus may comprise: receiving by the first apparatus one or more candidate duty-cycling patterns, selecting by the first apparatus a candidate duty-cycling pattern from the one or more candidate duty-cycling patterns, wherein the duty-cycling pattern used by the first apparatus for power duty cycling during the TXOP interval is the selected candidate duty-cycling pattern. This example may serve as an implementation of the coordination example.

According to one example, the one or more candidate schedules may be communicated by the third apparatus to the first apparatus in one or more frames which may, for example, be referred to as setup frames. The one or more frames may include values of the schedule parameters of each candidate schedule. For example, the one or more frames may include fields that contain the values of the schedule parameters.

This example may serve as an implementation of the coordination example.

According to one example, the first apparatus may be configured to perform the selection of the candidate schedule based on traffic buffered in the first apparatus for communication on the communication channel. Alternatively, or additionally, the first apparatus may be configured to perform the selection of the candidate schedule based on a controlling, signalling or operational information received from the third apparatus. This example may serve as an implementation of the coordination example.

According to one example, the first apparatus may be configured to send the selected candidate schedule to the third apparatus and receive a confirmation of the selected candidate schedule from the third apparatus, wherein the schedule according to which the first apparatus operates is the selected candidate schedule for which the confirmation is received. In another example, if the selected candidate schedule is rejected by the third apparatus, the third apparatus may propose an alternative schedule for the first apparatus to use e.g., with one or more schedule parameters modified relative to the initially selected candidate schedule. The schedule according to which the first apparatus operates may be the proposed schedule. This example may serve as an implementation of the coordination example.

This example may provide an additional validation step by requiring the selected schedule to be confirmed by the third apparatus. This confirmation process may ensure that both apparatuses are aligned on the selected schedule, reducing the likelihood of conflicts or miscommunications.

According to one example, the selected candidate schedule may be communicated by the first apparatus to the third apparatus in a frame (e.g., a setup frame) which may include values of the schedule parameters of the selected candidate schedule or an index referencing the selected candidate schedule. The third apparatus may send the confirmation in a response frame indicating its acceptance or confirmation of the selected candidate schedule. This example may serve as an implementation of the coordination example.

According to one example, the first apparatus may be configured to: send one or more candidate schedules for sleep mode and awake mode to the third apparatus and receive from the third apparatus a selection of a candidate schedule of the candidate schedules, wherein the schedule according to which the first apparatus operates is the selected candidate schedule. This example may serve as an implementation of the coordination example.

This example may provide the advantage of simplicity and efficiency by allowing the third apparatus to directly select a single candidate schedule from those proposed by the first apparatus, reducing the need for further decision-making by the first apparatus. This approach may be straightforward and effective when the third apparatus has clear criteria for selecting the optimal schedule.

According to one example, the first apparatus may be configured to generate and transmit frames that contain multiple candidate schedules for sleep and awake modes. Each candidate schedule within these frames may, for example, be defined by values of the schedule parameters. Upon receiving these frames, the third apparatus may process or review the provided candidate schedules to select the most suitable candidate schedule based on the values of the schedule parameters. This selection may be communicated back to the first apparatus within a response frame, which specifies the chosen candidate schedule. Once the first apparatus receives this response frame, the first apparatus may adopt the selected candidate schedule and operate according to the specified timing, switching between sleep and awake modes as defined in the selected candidate schedule. This example may serve as an implementation of the coordination example.

According to one example, the first apparatus may be configured to send a set of candidate schedules for sleep mode and awake mode to the third apparatus, receive from the third apparatus a selection of a subset of the candidate schedules and select a candidate schedule of the subset of candidate schedules, wherein the schedule according to which the first apparatus operates is the selected candidate schedule. This example may serve as an implementation of the coordination example.

This example may offer greater flexibility by enabling the third apparatus to narrow down the options to a subset of schedules based on broader considerations, while allowing the first apparatus to make the final selection from this refined subset. This approach may be beneficial in scenarios where the first apparatus has more contextual information or preferences that should influence the final choice.

According to one example, the first apparatus may be configured to create and transmit the set of candidate schedules within one or more frames to the third apparatus. These candidate schedules may be provided as values of the schedule parameters in the frame. Upon receiving the frame, the third apparatus may analyze the set of candidate schedules and select a subset e.g., that aligns with network requirements, communication priorities, or energy efficiency goals. This subset of selected candidate schedules is then sent back to the first apparatus within one or more response frames. This response frame may indicate which subset of schedules are acceptable by the third apparatus. After receiving this subset, the first apparatus may then choose a specific candidate schedule from the subset. This selection might depend on criteria like remaining battery power, device priorities, or contextual information. The first apparatus may then operate in accordance with the selected candidate schedule. This process may allow for flexible negotiation and fine-tuning of schedules between the two apparatuses e.g., optimizing both the apparatus's operations and the network's efficiency. This example may serve as an implementation of the coordination example.

In one example, the first apparatus may be configured to detect the announcement of the time window and operate according to the schedule during the time window in response to detecting the announcement.

According to one example, the at least second apparatus is a second apparatus, wherein the first apparatus may be configured to: perform the operation during the time window according to the schedule in response to detecting a frame in the communication channel from the second apparatus, wherein the detected frame indicates the time window. The frame may, for example, be Request to Send (RTS) frame or a Clear to Send (CTS) frame or data frame. As used herein, RTS frame also refers to Multi-User RTS frame and CTS frame also refers to Multi-User CTS frame.

According to one example, the at least second apparatus may be a second apparatus, wherein the first apparatus may be configured to: in response to detecting that the time window is reserved for second communication by the second apparatus on the communication channel, set a timer to the time window, and operate in accordance with the schedule as the timer progresses. The second communication by the second apparatus may comprise sending and/or receiving data on the communication channel using at least part of time window.

By detecting that a time window is reserved for the second apparatus and setting a timer accordingly, the first apparatus can efficiently manage its schedule and avoid conflicts or interference on the communication channel.

The first apparatus may be configured to operate during the time window according to the schedule as follows. The first apparatus may be configured to transition to the sleep mode or to the awake mode within the time window in accordance with the schedule. For example, the first apparatus may be configured to transition to the sleep mode in response to an event which may be referred to as sleep trigger event. The sleep trigger event may include, for example, the end of a packet transmission on the communication channel, the detection of specific frames such as a Request to Send (RTS) frame or a Clear to Send (CTS) frame, the completion of a period of the awake mode, or a command from a coordinating device. In this case, the RTS/CTS frame may serve a dual purpose: detecting the time window and triggering a switch to sleep mode, indicating that the schedule begins with the sleep mode within the detected time window. These events signal the first apparatus to enter sleep mode. The first apparatus may be configured to transition to the awake mode in response to an event which may be referred to as awake trigger event. The awake trigger event may include, for example, an end of the completion of a period of the sleep mode, or generation of specific traffic types by the apparatus. These events signal the first apparatus to enter awake mode.

According to one example, the first apparatus may be configured to set the timer in accordance with the Network Allocation Vector (NAV) mechanism. The NAV mechanism may be a mechanism used to manage channel access and avoid collisions by indicating periods when the channel is expected to be occupied by another device. This coordination may ensure that the first apparatus aligns its operations with the reserved time window, optimizing channel usage and preventing interference.

According to one example, the first apparatus may be configured to: send, to the third apparatus, the schedule according to which the first apparatus may operate, and thereafter perform the first communication with the third apparatus on the communication channel during a time the first apparatus is in the awake mode of the schedule.

This may ensure both the first and third apparatuses are synchronized on the schedule, allowing for efficient and conflict-free communication. By sharing its schedule, the first apparatus may enable the third apparatus to anticipate and align its activities, optimizing channel usage.

According to one example, the third apparatus may be configured to: send an updated of the schedule or the schedule during the time window. For example, the first apparatus may wake up x milliseconds into the beginning of the time window, after which the schedule may be announced to the first apparatus.

This may ensure that the schedule information is updated and communicated in real-time, reducing the risk of outdated or conflicting schedules. It may allow both apparatuses to quickly adapt to any changes within an active communication period, enhancing flexibility and responsiveness in managing channel access and coordination.

According to one example, the schedule comprises a time pattern of sleep and awake intervals, wherein the first apparatus is configured to be in the sleep mode during the sleep intervals and to be in the awake mode during the awake intervals. The time pattern may, for example, be the duty-cycling pattern.

According to one example, the at least second apparatus comprises multiple second apparatuses. The time window covers multiple time intervals that are set by the second apparatuses respectively for the second communication by the second apparatuses on the communication channel during the time intervals respectively. The schedule, according to which the first apparatus operate, comprises a time pattern of sleep and awake intervals per time interval of the time intervals. Each second apparatus of the multiple apparatuses may be configured to perform its respective second communication on at least part of the time interval that was set by the second apparatus.

According to one example, each apparatus of the first, second and third apparatuses may be a station. The time intervals may be TXOP intervals. The schedule, according to which the first apparatus operate, comprises a duty-cycling pattern per TXOP interval of the TXOP intervals.

According to one example, the time pattern is a fixed pattern or an extendable pattern. For example, the duty-cycling pattern may be a fixed pattern or adjustable pattern.

According to one example, the first apparatus may be configured to during the time window: receive data during an awake interval of the extendable pattern and adapt a length of the awake interval in response to determining a need for completion of the reception.

This example may provide flexibility in managing the awake interval, allowing the first apparatus to extend the duration as needed to complete data reception. This adaptability may help ensure that critical data transmissions are not interrupted or prematurely cut off.

According to one example, the schedule is synchronized with further schedules of further first apparatuses, wherein each further schedule of the further schedules enables a first communication by the respective first apparatus on the communication channel during the first apparatus's awake mode during the time window. For example, each first apparatus of the first apparatuses may be configured to perform its respective first communication according to the respective schedule.

In one example, the further first apparatuses may be part of the set of contending apparatuses for the communication channel.

This may enable the third apparatus to transmit simultaneously data to the first apparatuses and to the at least second apparatus if the third apparatus is not one the at least second apparatus. For instance, the third apparatus being an access point may leverage downlink Orthogonal Frequency Division Multiple Access (DL OFDMA) to transmit data to the first apparatuses being multiple stations simultaneously or implement a TXOP sharing instance or a Preemption Opportunity (PO) period to enable stations with Low-Latency (LL) traffic to preempt the TXOP.

According to one example, the first apparatus may be configured to: perform the operation according to the schedule in response to determining that the first communication is prescheduled between the first apparatus and a third apparatus during the time window. Alternatively, the operation according to the schedule may be automatically performed in response to detecting the time window.

According to one example, the first apparatus may be configured to: receive from the third apparatus a control frame indicative of the setting of the time window and select the schedule from multiple schedules based on the control frame. The multiple schedules may, for example, be provided by the third apparatus.

In another example, the first apparatus may have access to information indicative of the setting of the time window. The first apparatus may, for example, select the schedule from multiple schedules based on the information.

In one example, the time window is TXOP interval, wherein the control signal may comprise an announcement of whether TXOP preemption and/or TXOP sharing are enabled for the third apparatus on the TXOP interval. The setting of the time window may indicate whether TXOP preemption and/or TXOP sharing are enabled for the third apparatus on the TXOP interval.

According to one example, the first apparatus may be a station such as a user device and the third apparatus may be a station such as an access point. The time window may be a TXOP duration. The third apparatus may announce whether TXOP preemption and/or TXOP sharing is enabled. The first apparatus may receive this announcement. In response to receiving this announcement, the first apparatus may select the duty-cycling pattern according to which may operate from multiple predefined duty-cycling patterns. For example, the predefined duty-cycling patterns may comprise three duty-cycling patterns named as “Duty-Cycle Pattern 1”, “Duty-Cycle Pattern 2” and “Duty-Cycle Pattern 3” each associated with different configurations of TXOP enablement. This example may enable to switch between the three duty-cycling patterns, demonstrating how station behavior may be influenced by the enabling or disabling the TXOP preemption and TXOP sharing features. If both features are disabled, the first apparatus may adopt Duty-Cycle Pattern 1. However, if TXOP preemption is disabled and TXOP sharing is enabled, the first apparatus may adopt Duty-Cycle Pattern 2. Conversely, if TXOP preemption is enabled, regardless of the status of TXOP sharing, the first apparatus may adopt Duty-Cycle Pattern 3, which may require them to wake up more frequently than Duty-Cycle Pattern 2.

According to one example, the third apparatus is an access point of a network of the wireless communication system, the first apparatus being associated with the access point in the network.

According to one example, the time window is reserved by the second apparatus for performing the second communication on the communication channel with one or more other apparatuses in a network of the wireless communication system which is the same or different from a network comprising the first apparatus.

According to one example, the third apparatus may be configured to receive a reservation offer for reserving at least part of the time window for enabling communications by the third apparatus and accept or reject the reservation request based on the schedule of the first apparatus.

The reservation offer may be received by the third apparatus from the second apparatus that sets the time window.

According to one example, the third apparatus may be configured to: upon accepting the reservation offer, perform the communication with the first apparatus during a time the first apparatus is in the awake mode.

According to one example, the first communication by the first apparatus in the awake mode during the time window may comprise a reception of low latency (LL) data. For example, the third apparatus may be triggered, by a LL application, to provide the LL data to the first apparatus. While the present subject matter may be used in cases where LL is involved, it is not so limited to such transmission and is applicable to any other transmission category.

The first apparatus may thus be referred to as a LL STA. The LL STA may be a station that either has a low latency data session such as XR which typically has stringent latency requirements of a few milliseconds, or a station that has low latency data frames in the buffer; this can for example be a sensor reading which needs to be reported with a short delay, e.g. a few milliseconds or a station that has data buffered that has a deadline to be transmitted within a few milliseconds.

In one example, the first apparatus and the third apparatus may belong to a same network, named first network, of the wireless communication system. The at least second apparatus may belong to the first network or to a second network of the wireless communication system different from the first network. In one example, the second apparatus may be the third apparatus. In another example one of the at least one second apparatuses may be the third apparatus. This may be particularly advantageous in case the third apparatus is an access point that serves both the first and second apparatuses in the same first network. In one example, the first apparatus may be a non-AP station, the third apparatus may be an access point, wherein the at least one second apparatus may be an access point of the second network or one or more non-AP stations of the second network or the first network. The first network and the second networks may, for example, be Basic Service Sets (BSSs) respectively, and if they are different, they may form two overlapping BSSs which may be referred to OBSSs.

As described herein the coordination example may involve communication between the first and the third apparatus. This may involve signalling. In order to perform the signaling for the coordination example, some methods such as Target Wakeup Time (TWT) can be used. Alternatively, some enhancements to Stream Classification Services (SCS) or QoS Characteristics can be applied to support such signaling.

The first, second and third apparatuses may comprise stations respectively. For example, the first apparatus may comprise a station such as STA_{X}, the one or more second apparatuses may comprise stations such as STA_{Z} and the third apparatus may comprise a station such as STA_{Y}. The following listed methods may be provided. In the following, each action is described as being performed solely by a station for simplicity. However, one or more additional components of the respective apparatus may also be involved or used by the station to perform the action.
Station STA_{X} coordinates with another station STA_{Y} its duty-cycling pattern for those TXOPs obtained by other stations such as STA_{Z} (in its BSS or OBSSs).
If station STA_{Z} is same as station STA_{Y}, the coordination may be between stations STA_{X} and STA_{Z}

The coordination may be initiated by the either party or both
Station STA_{X}, which has coordinated its duty-cyclin pattern with station STA_{Y}, may perform power duty cycling during TXOPs that are obtained by other stations; the TXOPs that are obtained by other stations refer to the TXOPs that did not initially include station STA_{X} when performing reservation (e.g., when exchanging RTS/CTS).
Station STA_{Y} that is aware of the duty-cycling pattern of other stations such as station STA_{X}:
may communicate with the duty-cycling stations such as station STA_{X} during TXOPs that the duty-cycling stations (STA_{X}) have not been engaged in during the awake cycle
may decide, based on the duty-cycling pattern of stations, if TXOP sharing from other stations such as STA_{Z} can be accepted or declined.

A station that is aware of the duty-cycling pattern of other stations: may try to coordinate the duty-cycling pattern of the stations in a way that they wake up at certain times and/or certain durations, to enhance the operation of methods such as TXOP preemption and TXOP sharing.

A station may coordinate, adopt, negotiate, or switch between different duty-cycling patterns depending on:

The features enabled in the network, e.g., TXOP preemption, TXOP sharing Its demand for exchanging traffic, e.g., type and amount of LL traffic.

The listed methods may, for example, comprise the following features.
Non-AP station may signal to its associated APs its duty-cycling pattern for those TXOPs obtained by other stations (in its BSS or OBSSs)
Non-AP station may perform sleep-awake duty cycling during the TXOPs that are obtained by other stations
If the access point associated with the non-AP station is aware of the duty-cycling pattern of the non-AP station, the access point may communicate with the non-AP station during the TXOPs shared by other access points
If the access point associated with the non-AP station is aware of the duty-cycling pattern of the non-AP station, the access point may communicate with the non-AP station during the TXOPs obtained by the access point when the non-AP station was not initially involved in TXOP reservation
If the access point associated with the non-AP station is aware of the duty cycling pattern of the non-AP station, the access point may communicate with the non-AP station during the TXOPs shared by a non-AP station associated with the access point
An access point that is receiving a TXOP sharing offer from another access point may rely on the duty cycle pattern of its associated non-AP stations to decide if the offered TXOP can be accepted or declined
Non-AP stations may decide to use the awake pattern only when they are expecting to receive LL traffic from their associated accesspoint or have LL traffic to send to their associated access point
The access point may synchronize the duty-cycle pattern of non-AP stations; this may enable the access point to enhance the efficiency of methods such as downlink multi-user packet delivery, TXOP preemption, etc.
Non-AP stations, depending on the properties of their buffered traffic, may choose one of the duty-cycling patterns offered by the access point to synchronize their duty-cycle operation, while also maintaining their desired power efficiency level.

It is understood that one or more of the aforementioned examples may be combined as long as the combined examples are not mutually exclusive.

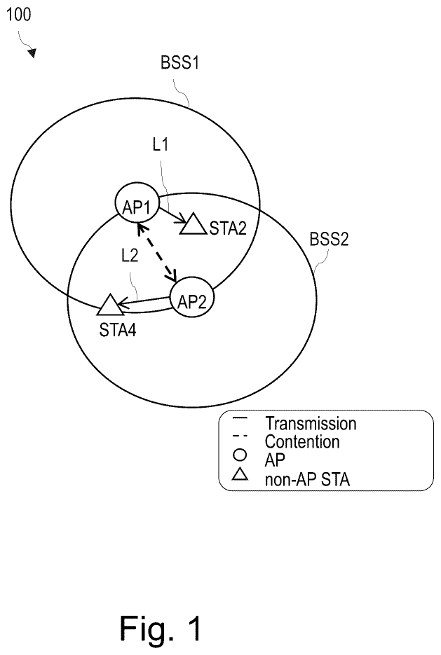

FIG. 1 illustrates an example wireless communication system in which the present subject matter may be implemented in accordance with an example. The wireless communication system 100 is a Wi-Fi system comprising two neighboring BSSs, BSS1 and BSS2. BSS1 includes a station STA1 which may be an access point AP1 and a station STA2, while BSS2 similarly comprises a station STA3 which many be an access point AP2 and a station STA4.

As illustrated in FIG. 1 within BSS1, the access point AP1 and the station STA2 may be a pair of apparatuses that define a communication link L1 through a communication channel, with one apparatus functioning as the transmitter and the other apparatus as the receiver. In BSS2, the access point AP2 and the station STA4 may be a pair of apparatuses that define a communication link L2 through the communication channel, with one apparatus functioning as the transmitter and the other apparatus as the receiver.

To transmit data over the two communication links, L1 and L2, using the same communication channel, an example mechanism for energy saving can be employed. For instance, virtual carrier sensing can be achieved by having access point AP1, the TXOP holder, reserves a TXOP to communicate with station STA2, the TXOP responder. Access point AP1 may send a RTS frame, and station STA2 responds with a CTS frame. When other stations, such as station STA4, detect the RTS, CTS, or data frames exchanged between access point AP1 and station STA2, they set their NAV to indicate that the channel is occupied. During this reserved period, station STA4 may switch to sleep mode to conserve energy. However, this poses an issue if access point AP1 needs to deliver low-latency frames to station STA4, as station STA4 was not addressed in the RTS/CTS exchange and, therefore, is not reserved for communication on the communication channel. With the station STA4 in sleep mode, access point AP1 cannot perform the transmission, which becomes problematic in scenarios, where access point AP1, as the TXOP holder, is allowed to transmit frames to other stations. Additionally, if the access point AP1 shares its TXOP with access point AP2, access point AP2 is also unable to transmit to station STA4 while it remains in sleep mode.

To address this issue, the station STA4 may be configured to operate in accordance with a schedule, during the TXOP interval. The schedule defines a sleep mode and an awake mode of the station STA4 within the TXOP interval, to enable a communication e.g. reception of LL traffic from access point AP1, by the station STA4 on the communication channel during a time the station STA4 is in the awake mode during the TXOP interval.

For simplicity, only two wireless networks are illustrated, with each network consisting of one access point and one station. However, it is not limited to as this configuration can be expanded to include multiple networks and multiple access points and stations within each network, depending on the specific requirements or use case.

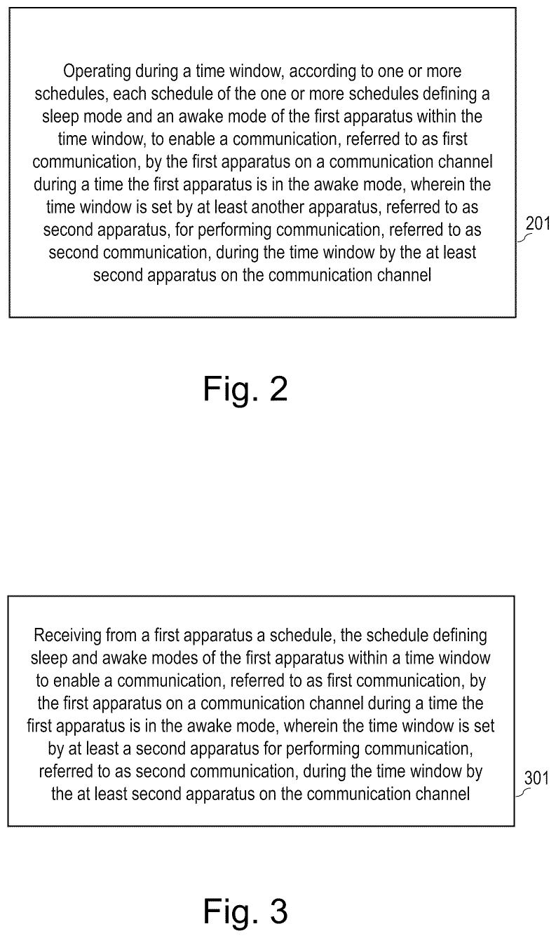

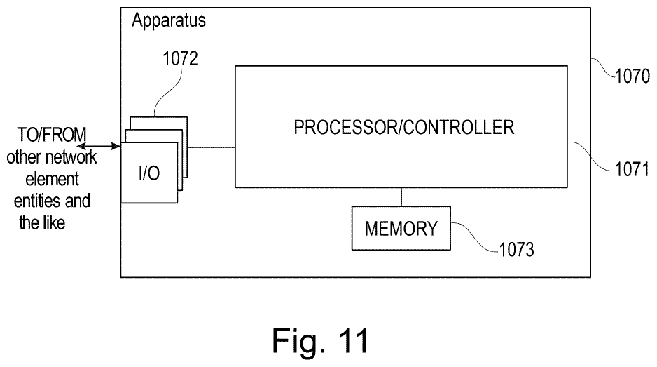

FIG. 2 is a flowchart of a method for communication on a communication channel of a wireless communication system in accordance with an example of the present subject matter. The method of FIG. 2 may, for example, be performed by a first apparatus such as the apparatus of FIG. 11 or the station STA4 of FIG. 1.

The first apparatus may operate in step 201 during a time window, according to one or more schedules. Each schedule of the one or more schedules defining a sleep mode and an awake mode of the first apparatus within the time window, to enable a communication, referred to as first communication, by the first apparatus on a communication channel during a time the first apparatus is in the awake mode. The time window is set by at least another apparatus, referred to as second apparatus, for performing communication, referred to as second communication, during the time window by the at least second apparatus on the communication channel.

FIG. 3 is a flowchart of a method for communication on a communication channel of a wireless communication system in accordance with an example of the present subject matter. The method of FIG. 2 may, for example, be performed by a third apparatus such as the apparatus of FIG. 11 or the access point AP2 of FIG. 1.

The third apparatus may receive in step 301 from a first apparatus at least one schedule, the schedule defining sleep and awake modes of the first apparatus within a time window to enable a communication, referred to as first communication, by the first apparatus on a communication channel during a time the first apparatus is in the awake mode, wherein the time window is set by at least a second apparatus for performing communication, referred to as second communication, during the time window by the at least second apparatus on the communication channel.

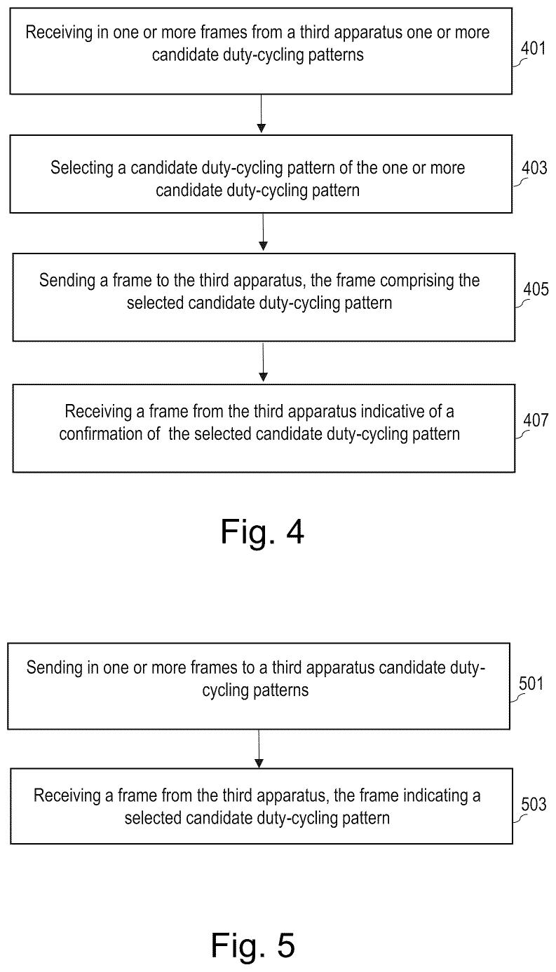

FIG. 4 is a flowchart of a coordination method for determining a schedule in accordance with an example of the present subject matter. For the purpose of explanation, the coordination method described in FIG. 4 may be implemented in the system illustrated in FIG. 1 but is not limited to this implementation The coordination method of FIG. 4 may, for example, be performed by a first apparatus such as the station STA4 and the third apparatus such as the access point AP2.

The station STA4 may receive, in step 401, in one or more frames from the access point AP2 one or more candidate duty-cycling patterns. The station STA4 may select, in step 403, a candidate duty-cycling pattern of the one or more candidate duty-cycling pattern. The station STA4 may send, in step 405, a frame to the access point AP2, the frame comprising the selected candidate duty-cycling pattern. The station STA4 may receive, in step 407, a frame from the access point AP2 indicative of a confirmation of the selected candidate duty-cycling pattern. The selected candidate duty-cycling pattern may be used as a schedule for operation of the station STA4 during a TXOP interval which is held by the access point AP1 and reserved for communication between the access point AP1 and the station STA2.

FIG. 5 is a flowchart of a coordination method for determining a schedule in accordance with an example of the present subject matter. For the purpose of explanation, the coordination method described in FIG. 4 may be implemented in the system illustrated in FIG. 1 but is not limited to this implementation The coordination method of FIG. 4 may, for example, be performed by a first apparatus such as the station STA4 and the third apparatus such as the access point AP2.

The station STA4 may send, in step 501, one or more frames to the access point AP2. The one or more frames comprise candidate duty-cycling patterns. The station STA4 may receive, in step 503, a frame from the access point AP2, the frame indicating a selected candidate duty-cycling pattern of the candidate duty-cycling patterns. The received selected candidate duty-cycling pattern may be used as a schedule for operation of the station STA4 during a TXOP interval which is held by the access point AP1 and reserved for communication between the access point AP1 and the station STA2.

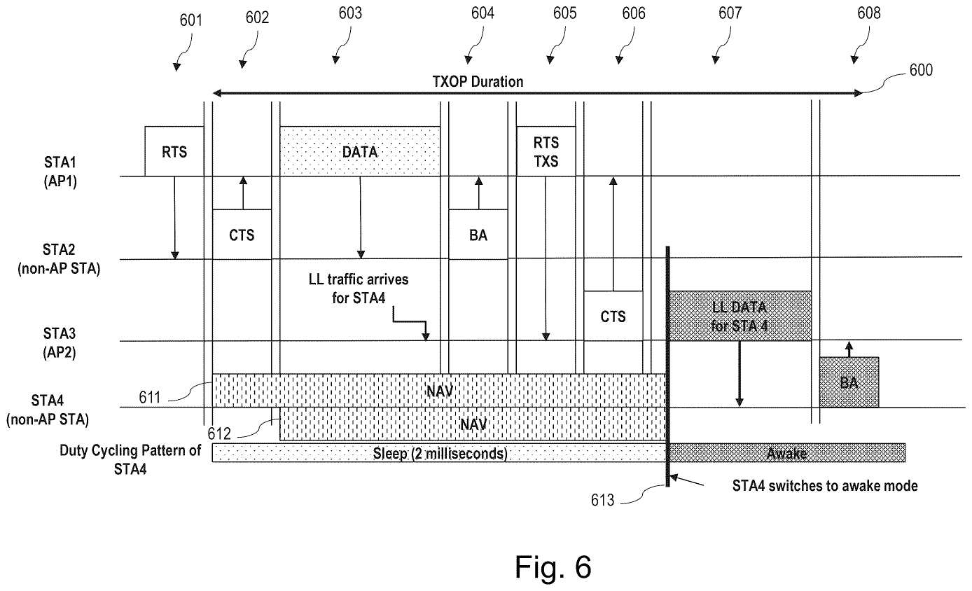

FIG. 6 is a diagram illustrating the status of the access to the communication channel by a set of stations (e.g., as described with reference to FIG. 1): access point AP1, access point AP2, STA2 and STA4 in accordance with an example of the present subject matter. Each station of the set of stations is associated with a timeline that outlines the operations it performs. The timeline defines specific timing intervals involved in the station's communications. For simplicity in the drawing, the timing interval for a frame's transmission may be the same as the timing interval for its reception, where the frame may be a data frame or control frame.

In this example, the transmissions occur within a TXOP duration or TXOP interval 600 during which the station STA2 and access point AP1 may have the exclusive right to transmit frames on the communication channel.

The access point AP1 may send (601) to the station STA2 a RTS frame, indicating a request to reserve the communication channel. The station STA2 responds (602) to the RTS frame with a CTS frame to indicate that the communication channel is clear for data transmission.

Station STA4 may detect the RTS frame sent by access point AP1 (601) or the CTS frame sent by station STA2 (602). Although station STA4 is not involved in the ongoing communication on the communication channel, it is configured to monitor and listen to these RTS and CTS frames. Each frame of the RTS frame and the CTS frame includes a Duration field that indicates the length of the TXOP interval (600). Upon detecting either the RTS or CTS frame, STA4 sets its NAV timer (611, 612) to the value specified in the Duration field of the corresponding frame.

The access point AP1 may send (603) data to the station STA2, indicating successful communication channel access. After transmitting the data, the access point AP1 receives (604) a Block Acknowledgement (BA) frame from the station STA2, confirming successful reception of the data. The access point AP1 may send (605) an RTS frame along with a TXOP Sharing (TXS) to the access point AP2, offering a shared TXOP, which is acknowledged (606) by the access point AP2 through a CTS frame. RTS frame also refers to Multi-User RTS frame. CTS frame also refers to Multi-User CTS frame.

The station STA4 has, according to this example, a distinct duty-cycling pattern. The station STA4 may have informed access point AP2 with the duty-cycling pattern so the access point AP2 may use the shared TXOP (received from access point AP1) to communicate with the station STA4 when the station STA4 wakes up. For example, with the duty-cycling pattern, the station STA4 remains in sleep mode for 2 milliseconds. During this period, the station STA4 does not participate in the transmissions on the communication channel. After the 2 milliseconds of sleep, the station STA4 wakes up and switches to awake mode, signified by the vertical line 613. This may result in stopping the NAV timer 611 as indicated in FIG. 6. In the awake mode, the station STA4 receives (607) data from the access point AP2, followed by sending (608) by the station STA4 a BA to access point AP2, indicating successful reception.

The time interval between the end of the RTS frame (or CTS) frame and the start of the NAV timer may represent the period during which the station STA4 wakes up to transmit the schedule to the access point AP2.

Indeed, the diagram of FIG. 6 may be provided as an example implementation of the following. Each non-AP station may coordinate its duty-cycling pattern (sleep-awake cycles) with at least its associated AP. This coordination may be initiated by the non-AP station, the access point AP, or a hybrid of both methods. The coordination between non-AP stations and access points may be conducted in different ways, such as the following:
The access point may announce one or more duty cycling patterns that may be used by non-AP stations to duty cycle during TXOPs
Each non-AP station may signal an awake pattern to their associated acess point
Example 1: The station will be duty cycling between sleep and awake modes where the sleep duration is x milliseconds and awake duration is y milliseconds
   Such a schedule may be announced and used for the TXOP durations only (when NAV is set)
   Such a schedule may be announced and used for the overall operation of the station, i.e., within and outside of NAV periods.
Example 2: The station will wake up x milliseconds into the TXOP, after which a new schedule may be announced
Access point and non-AP station may negotiate the duty cycling pattern

While the present subject matter may be used in cases where LL is involved, it is not so limited to such transmission and is applicable to any other transmission category. However, in certain cases where LL data is used, if a non-AP station does not need or expect to receive LL traffic from its associated accesspoint, then the station may not need to engage in duty cycling during a TXOP reserved by another sTA. Such a station may, for example, not need to exchange any signaling information with its access point about its duty-cycling pattern.

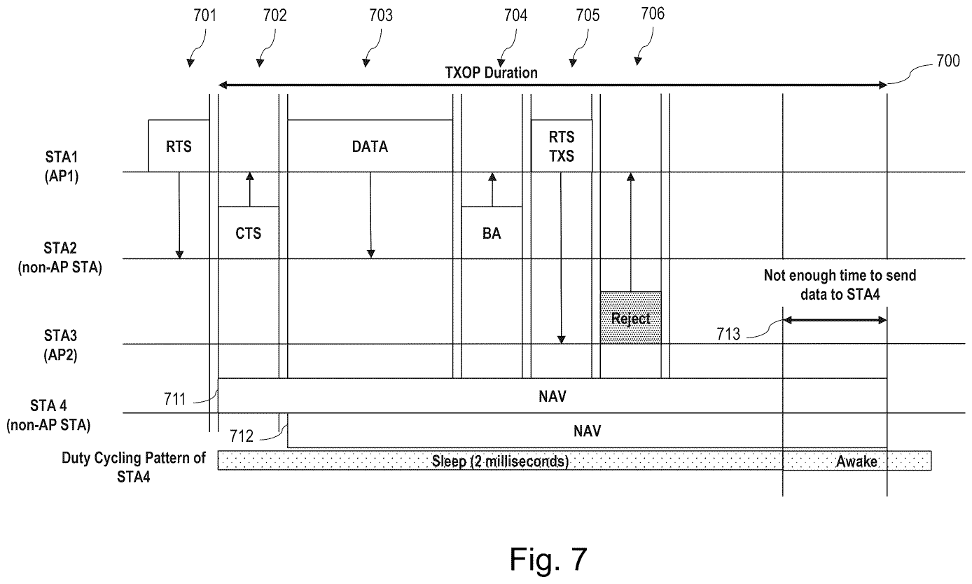

FIG. 7 is a diagram illustrating the status of the access to the communication channel by a set of stations (e.g., as described with reference to FIG. 1): access point AP1, access point AP2, STA2 and STA4 in accordance with an example of the present subject matter. Each station of the set of stations is associated with a timeline that outlines the operations it performs. The timeline defines specific timing intervals involved in the station's communications. For simplicity in the drawing, the timing interval for a frame's transmission may be the same as the timing interval for its reception, where the frame may be a data frame or control frame.

In this example, the transmissions occur within a TXOP duration or TXOP interval 700 during which the station STA2 and access point AP1 may have the exclusive right to transmit frames on the communication channel.

The access point AP1 may send (701) to the station STA2 a RTS frame, indicating a request to reserve the communication channel. The station STA2 responds (702) to the RTS frame with a CTS frame to indicate that the communication channel is clear for data transmission.

Station STA4 may detect the RTS frame sent by access point AP1 (601) or the CTS frame sent by station STA2 (602). Although station STA4 is not involved in the ongoing communication on the communication channel, it is configured to monitor and listen to these RTS and CTS frames. Each frame of the RTS frame and the CTS frame includes a Duration field that indicates the length of the TXOP interval (600). Upon detecting either the RTS or CTS frame, STA4 sets its NAV timer (711, 712) to the value specified in the Duration field of the corresponding frame. The station STA4 has, according to this example, a distinct duty-cycling pattern. The station STA4 may have informed access point AP2 with the duty-cycling pattern so the access point AP2 may use the shared TXOP (received from access point AP1) to communicate with the station STA4 when the station STA4 wakes up. For example, with the duty-cycling pattern, the station STA4 remains in sleep mode for 2 milliseconds. During this period, the station STA4 does not participate in the transmissions on the communication channel. After the 2 milliseconds of sleep, the station STA4 wakes up and switches to awake mode. The access point AP1 may send (703) data to the station STA2, indicating successful communication channel access. After transmitting the data, the access point AP1 receives (704) a BA frame from the station STA2, confirming successful reception of the data. The access point AP1 may send (705) an RTS frame along with a TXS to the access point AP2, offering a shared TXOP. However, due to the duty-cycling pattern of the station STA4, which remains in a sleep mode for 2 milliseconds, there is not enough remaining (713) TXOP time for the access point AP2 to successfully transmit data to the station STA4. Hence, recognizing that the station STA4 will not wake up within the available remaining (713) TXOP duration, the access point AP2 decides to reject (706) the TXOP sharing offer from the access point AP1, as depicted by the “Reject” box. This decision may be based on the inability to send low-latency (LL) traffic to station STA4 within the time constraints.

Hence, the diagram demonstrates the logic of enhanced TXOP sharing: access point AP2 receives a TXOP sharing offer from access point AP1. Access point AP2 considers the duty-cycling pattern of its associated stations (in this case, STA4) to decide whether to accept or decline the offer. For instance, if the remaining time of the shared TXOP is r milliseconds, while station STA4 will wake up in r+k milliseconds, access point AP2 may decline the offer because it cannot use this TXOP to transmit low-latency traffic to the station STA4.

The time interval between the end of the RTS frame (or CTS) frame and the start of the NAV timer may represent the period during which the station STA4 wakes up to transmit the schedule to the access point AP2.

Indeed, the diagram of FIG. 7 may be provided as an example implementation of the following. Enhanced TXOP sharing: When access point APX receives a TXOP sharing offer from access point APY, access point APX may rely on the duty-cycling pattern of its associated stations to decide if the offer may be accepted or declined. For instance, if the remaining time of the shared TXOP is r milliseconds, while station STAW that is associated with access point APY will wake up in r+k milliseconds, then access point APY may decide to decline the offer as it cannot use this TXOP to send LL traffic to station STAW.

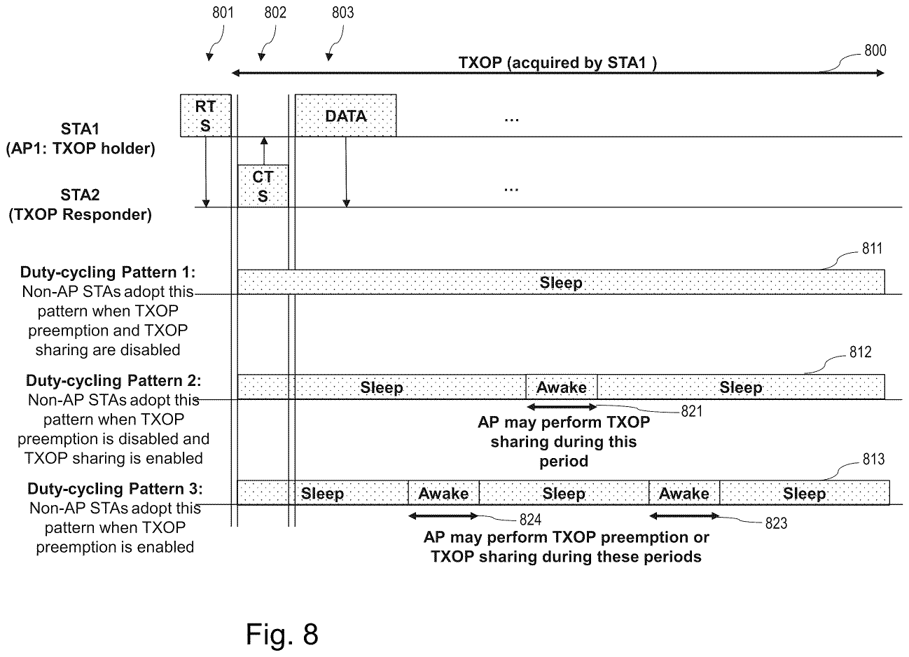

FIG. 8 is a diagram illustrating a method for determining a duty-cycling pattern in accordance with an example of the present subject matter. The diagram illustrates the status of the access to the communication channel by a set of stations (e.g., as described with reference to FIG. 1) comprising an access point AP1 and its associated station STA2. Each station of the set of stations is associated with a timeline that outlines the operations it performs. The timeline defines specific timing intervals involved in the station's communications. For simplicity in the drawing, the timing interval for a frame's transmission may be the same as the timing interval for its reception, where the frame may be a data frame or control frame.

In this example, the transmissions occur within a TXOP duration or TXOP interval 800 during which the station STA2 and access point AP1 may have the exclusive right to transmit frames on the communication channel.

The access point AP1 may send (801) to the station STA2 a RTS frame, indicating a request to reserve the communication channel. The station STA2 responds (802) to the RTS frame with a CTS frame to indicate that the communication channel is clear for data transmission (803).

The diagram illustrates three different duty-cycling patterns 811 through 813 that one or more other stations willing to transmit and/or receive data within that period 700 may adopt or switch between:

The duty-cycling pattern 811 named Duty-Cycling Pattern 1 may be adopted when both TXOP preemption and TXOP sharing are disabled, where stations remain in an extended sleep mode.

The duty-cycling pattern 812 named Duty-Cycling Pattern 2 is adopted when TXOP preemption is disabled but TXOP sharing is enabled; in this case, the stations may periodically enter an awake mode, during which the access point AP associated with these stations may perform TXOP sharing, as indicated by segment (821) in the diagram, showing that the stations are ready to communicate within those designated times. This may introduce flexibility, allowing the access point AP to utilize shared TXOPs for transmitting data during these awake periods.

Duty-Cycling Pattern 3 is adopted when TXOP preemption is enabled, regardless of whether TXOP sharing is enabled or disabled. In this pattern, the stations wake up more frequently than in Pattern 2, as indicated by multiple segments (823 and 824), and the access point associated with these stations may have the option to perform both TXOP preemption and TXOP sharing during these awake intervals, indicating the potential for prioritizing data transmissions by preempting the existing TXOP holder. Indeed, the diagram of FIG. 8 may be provided as an example implementation of the following. Non-AP stations may adopt, negotiate or switch between different duty-cycling patterns. The switching may be triggered by the AP's announcements or based on the demands of non-AP stations. For instance, enabling and disabling TXOP preemption and TXOP sharing may result in adopting different duty-cycling patterns by the STAs. An example of switching between different duty-cycling patterns is presented in FIG. 8, demonstrating how station behavior may be influenced by the combination of TXOP preemption and TXOP sharing. If both features are disabled, non-AP stations may adopt Duty-Cycle Pattern 1. However, if TXOP preemption is disabled and TXOP sharing is enabled, non-AP stations may adopt Duty-Cycle Pattern 2. Conversely, if TXOP preemption is enabled regardless of the status of TXOP sharing, non-AP stations may adopt Duty-Cycle Pattern 3, which may require them to wake up more frequently than Duty-Cycle Pattern 2.

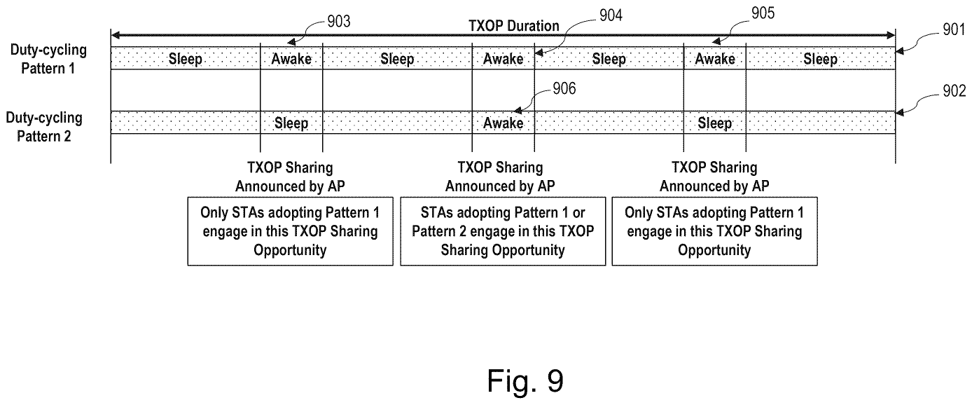

FIG. 9 is a diagram illustrating two duty-cycling patterns 901 and 902 with synchronized awake times of stations in accordance with an example of the present subject matter. The duty-cycling pattern 901 named Duty-Cycling Pattern 1 is depicted as alternating periods of sleep and awake modes, with stations scheduled to wake up periodically at synchronized intervals marked with segments 903 through 905, allowing only stations adopting it to participate in the Preemption Opportunity periods announced by the access point. The duty-cycling pattern 902 named Duty-Cycling Pattern 2 may also alternate between sleep and awake modes, but with fewer awake periods 906 compared to the duty-cycling pattern 901, indicated by segments 903 through 905 showing active intervals. During the Preemption Opportunity, stations adopting either duty-cycling pattern 901 or duty-cycling pattern 902 are eligible to engage. The access point announces a Preemption Opportunity at specific intervals within the TXOP Duration, designed to enable stations with LL traffic to preempt the current TXOP and transmit their urgent data, specifying which stations based on their adopted duty-cycling pattern are eligible to participate in each Preemption Opportunity (PO) period. Synchronization of the awake times of stations may enhance network performance, as it may allow the access point to leverage Downlink Orthogonal Frequency Division Multiple Access (DL OFDMA) to transmit data to multiple stations simultaneously or implement the PO periods to allow LL traffic to preempt the current TXOP. This synchronization may be achieved by the access point announcing these multiple duty-cycling patterns, each having synchronized instances of awake times, from which stations can select based on the characteristics of their buffered traffic to optimize efficiency and reduce overhead.

Indeed, the diagram of FIG. 9 may be provided as an example implementation of the following. Synchronization of the awake time of stations: Synchronizing the awake time of stations may significantly improve performance, allowing for more efficient use of resources and higher throughput. For instance, the access point may leverage DL OFDMA to transmit data to multiple stations simultaneously or implement a Preemption Opportunity (PO) period to enable stations with LL traffic to preempt the TXOP. To achieve this synchronization, multiple methods may be employed. One such approach may involve the access point announcing a set of multiple duty-cycling patterns, each with synchronized instances of awake times. By selecting from these options based on the characteristics of their buffered traffic, non-AP stations may optimize their duty-cycling patterns to minimize overhead and maximize efficiency.

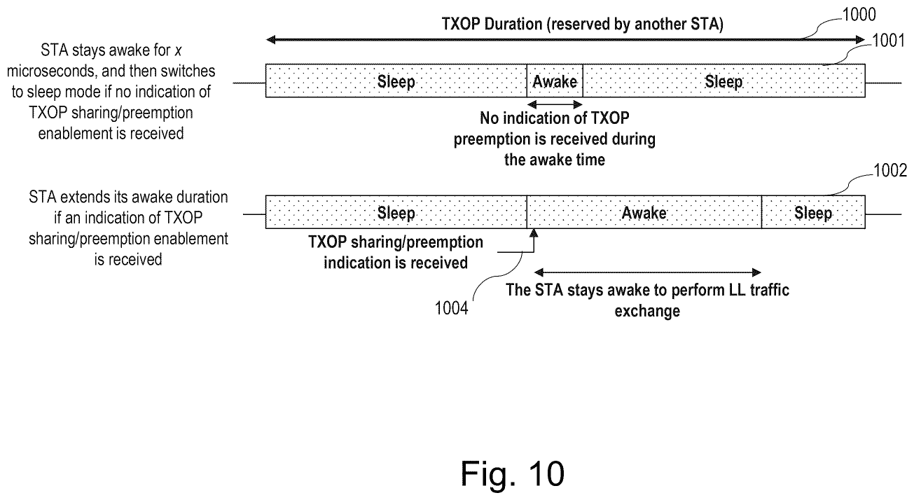

FIG. 10 is a diagram illustrating two scenarios involving extendable and non-extendable awake durations for a station within a TXOP period 1000 that is reserved by another station in accordance with an example of the present subject matter.

The first line 1001 depicts a non-extendable awake duration where the station wakes up for a predetermined period of x microseconds within the TXOP. During this period, the station remains awake to determine if an indication of TXOP preemption enablement is received. If no such indication is received, the station returns to sleep mode as scheduled, without extending its awake duration.

In contrast, the second line 1002 illustrates an extendable awake duration. Here, the station wakes up at a specified time and stays awake for at least x microseconds. During this period, the station monitors for an indication of TXOP preemption enablement. If an indication of TXOP preemption is received (as shown by the arrow 1004), the station extends its awake duration to remain active and compete for channel access to send low-latency (LL) traffic. This adaptive behavior may allow the station to respond dynamically based on whether preemption is permitted, maintaining its awake state only when necessary.

This type of specification, where the awake duration is conditional based on network conditions, is referred to as extendable. Conversely, a non-extendable wake-up duration maintains a fixed awake period, independent of frame transmissions or indications of preemption. This flexibility may allow stations to efficiently manage energy consumption while remaining responsive to preemption signals within the TXOP duration.

Indeed, the diagram of FIG. 10 may be provided as an example implementation of the following. When a non-AP station may adopt a duty-cycling pattern, the awake duration of the duty-cycle may not represent a fixed duration. For instance, a non-AP station may wake up every y microsecond into the TXOP, stay awake for at least x microseconds, and extend its awake duration if needed. This type of wake-up duration specification may be referred to as extendable. Therefore, the awake duration of stations may be extendable or non-extendable. An extendable wake-up duration may refer to the case where a station extends its awake duration only if needed. For instance, a station may wake up at a certain time and stay awake for x microsecond to determine if TXOP sharing or TXOP preemption is allowed. If sharing/preemption is allowed, the station may extend its awake duration; otherwise, the station may return to sleep mode. A non-extendable wake-up duration may refer to a duty-cycling pattern where the awake duration of the station is fixed, regardless of the reception/transmission of frames during the wake period.

In FIG. 11, a block circuit diagram illustrating a configuration of an apparatus 1070 is shown, which is configured to implement at least part of the present subject matter. The apparatus may be a user equipment or an access point for wireless communication. It is to be noted that the apparatus 1070 shown in FIG. 11 may comprise several further elements or functions besides those described herein below, which are omitted herein for the sake of simplicity as they are not essential for the understanding. Furthermore, the apparatus may be also another device having a similar function, such as a chipset, a chip, a module etc., which can also be part of an apparatus or attached as a separate element to the apparatus 1070, or the like. The apparatus 1070 may comprise a processing function or processor, or controller 1071, such as a central processing unit (CPU) or the like, which executes instructions given by programs or the like related to a flow control mechanism. The processor 1071 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 1072 denotes transceiver or input/output (I/O) units (interfaces) connected to the processor 1071. The I/O units 1072 may be used for communicating with one or more other network elements, entities, terminals or the like. The I/O units 1072 may be a combined unit comprising communication equipment towards several network elements or may comprise a distributed structure with a plurality of different interfaces for different network elements. Reference sign 1073 denotes a memory usable, for example, for storing data and instructions, such as programs to be executed by the processor 1071 and/or as a working storage of the processor 1071.

The processor 1071 is configured to execute processing related to the above described subject matter. In particular, the apparatus 1070 may be configured to perform the method as described in connection with FIG. 2, 3, 4 or 5.

For example, the processor 1071 is configured to perform: operate during a time window, according to one or more schedules, the schedule defining a sleep mode and an awake mode of a first apparatus within the time window, to enable a communication by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) (or media) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device.

‘Computer memory’ or ‘memory’ is an example of a computer-readable storage medium. Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1. An apparatus, referred to as first apparatus, for a wireless communication system, the first apparatus comprising at least one processor; and at least one memory storing instructions that, when executed by the at least one processor, cause the first apparatus at least to:
operate during a time window, according to one or more schedules, each schedule of the one or more schedules defining a sleep mode and an awake mode of the first apparatus within the time window, to enable a communication,, referred to as first communication, by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

2. The first apparatus of claim 1, wherein the instructions, when executed by the at least one processor, further cause the first apparatus to coordinate the one or more schedules with an apparatus, referred to as third apparatus, the third apparatus being one of the at least second apparatus or different from the at least second apparatus.

3. The first apparatus of claim 1, each apparatus of the first and second apparatuses being a station, the one or more schedules being a duty-cycling pattern, the time window comprising a TXOP interval, wherein operating according to the one or more schedules comprises performing a power duty cycling during the TXOP interval.

4. The first apparatus of claim 1, wherein the instructions, when executed by the at least one processor, further cause the first apparatus to:
receive from a third apparatus one or more candidate schedules for sleep and awake modes;
select a candidate schedule of the one or more candidate schedules, wherein the schedule is the selected candidate schedule.

5. The first apparatus of claim 4, wherein the instructions, when executed by the at least one processor, further cause the first apparatus to perform the selection of the candidate schedule based on traffic buffered in the first apparatus for communication on the communication channel.

6. The first apparatus of claim 4, wherein the instructions, when executed by the at least one processor, further cause the first apparatus to send the selected candidate schedule to the third apparatus and receive a confirmation of the selected candidate schedule from the third apparatus.

7. The first apparatus of claim 1, wherein the instructions, when executed by the at least one processor, further cause the first apparatus to:
send one or more candidate schedules for sleep mode and awake mode to a third apparatus;
receive from the third apparatus a selection of a candidate schedule of the candidate schedules; wherein the schedule is the selected candidate schedule.

8. The first apparatus of claim 1, wherein the instructions, when executed by the at least one processor, further cause the first apparatus to:
send a set of candidate schedules for sleep mode and awake mode to a third apparatus;
receive from the third apparatus a selection of a subset of the candidate schedules;
select a candidate schedule of the subset of candidate schedules,
wherein the schedule is the selected candidate schedule.

9. The first apparatus of claim 1, wherein the instructions, when executed by the at least one processor, further cause the first apparatus to: in response to detecting that the time window is reserved for communication by the second apparatus on the communication channel, start a timer at the beginning of the time window, wherein the instructions, when executed by the at least one processor, further cause the first apparatus to perform the operation in accordance with the schedule as the timer progresses.

10. The first apparatus of claim 1, wherein the instructions, when executed by the at least one processor, further cause the first apparatus to:
perform the operation during the time window according to the schedule in response to detecting a frame in the communication channel from the second apparatus indicating the time window.

11. The first apparatus of claim 1, wherein the instructions, when executed by the at least one processor, further cause the first apparatus to:
send the schedule to a third apparatus; and thereafter perform the first communication with the third apparatus during a time the first apparatus is in the awake mode.

12. The first apparatus of claim 1, the schedule comprising a time pattern of sleep and awake intervals, wherein the first apparatus is configured to be in the sleep mode during the sleep intervals and to be in the awake mode during the awake intervals.

13. The apparatus of claim 12, wherein the instructions, when executed by the at least one processor, further cause the first apparatus to during the time window:
receive data during an awake interval of the time pattern and adapt a length of the awake interval in response to determining a need for extending the awake interval.

14. The first apparatus of claim 1, wherein the schedule is synchronized with further schedules of further first apparatuses, wherein each further schedule of the further schedules enables a first communication by the respective first apparatus on the communication channel during the first apparatus's awake mode during the time window.

15. The first apparatus of claim 2, the third apparatus being an access point or base station of a network of the wireless communication system, the first apparatus being associated with the access point in the network.

16. The first apparatus of the claim 2, the third apparatus being a second apparatus of the at least second apparatus.

17. A method comprising: operating during a time window, according to one or more schedules, each schedule of the one or more schedules defining a sleep mode and an awake mode of an apparatus, referred to as first apparatus, within the time window, to enable a communication, referred to as first communication, by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel.

18. An apparatus, referred to as third apparatus, for a wireless communication system, the third apparatus comprising at least one processor; and at least one memory storing instructions that, when executed by the at least one processor, cause the third apparatus at least to:
receive from an apparatus referred to as first apparatus, one or more schedules, each schedule of the one or more schedules defining sleep and awake modes of the first apparatus within a time window to enable a communication, referred to as first communication, by the first apparatus on a communication channel during a time the first apparatus is in the awake mode, wherein the time window is set by at least another apparatus, referred to as second apparatus, for performing communication, referred to as second communication, during the time window by the at least second apparatus on the communication channel

19. The third apparatus of claim 18, wherein the instructions, when executed by the at least one processor, further cause the third apparatus to
provide multiple schedules of sleep and awake modes to apparatuses of the wireless communication systems including the first apparatus, wherein the received schedule is one of the multiple schedules.

20. The third apparatus of claim 18, wherein the instructions, when executed by the at least one processor, further cause the third apparatus to:
receive a reservation offer for reserving at least part of the time window for enabling communications by the third apparatus;
accept or reject the reservation offer based on the schedule.

21. The third apparatus of claim 20, wherein the instructions, when executed by the at least one processor, further cause the third apparatus to:
upon accepting the reservation offer, perform the first communication during a time the first apparatus is in the awake mode.
